(19) United States
(12) Patent Application Publication
(10) Pub. No.: US 2018/0141119 A1
(43) Pub. Date: May 24, 2018

(54) Metal Flake Composites and Methods of Making and Using the Same for Additive Manufacturing

(71) Applicants: Jun Shu, Mississauga (CA); Min Chen, Mississauga (CA); Manning Shu, Mississauga (CA)

(72) Inventors: Jun Shu, Mississauga (CA); Min Chen, Mississauga (CA); Manning Shu, Mississauga (CA)

(21) Appl. No.: 15/360,078

(22) Filed: Nov. 23, 2016

(51) Int. Cl. B22F 1/02; B22F 1/00; B22F 3/105; B22F 9/04; B33Y 10/00; B33Y 40/00; B33Y 70/00; B23K 11/00; B23K 11/16; B23K 15/00; B23K 26/00; B23K 26/342; B01J 2/00; B29B 7/00; B29C 67/00

(52) U.S. Cl. CPC B22F 1/025; B29K 2101/12; B22F 3/1055; B22F 9/04; B33Y 10/00; B33Y 40/00; B33Y 70/00; B23K 11/0013; B23K 11/163; B23K 15/0086; B23K 15/0093; B23K 26/0006; B23K 26/342; B01J 2/003; B29B 7/005; B29C 67/0077; B22F 2009/043; B22F 2301/052; B22F 2301/10; B22F 2301/15; B22F 2301/35; B22F 2301/30; B22F 2302/45; B22F 2304/10; B22F 2998/10; B22F 1/0014

(57) ABSTRACT

This patent describes metal flake composites consisting of metal flakes and thermoplastic resins as printing materials for additive manufacturing of prototypes with metallic appearance, improved mechanical properties and durability. Metal flakes of 5 to 50 microns in average size (D₅₀) and 0.2-2 microns in thickness are made of base metals such as aluminum, chromium, cobalt, copper, iron, nickel, tin, titanium, zinc, and their alloys, e.g., stainless steel, brass and bronze by ball milling metal powder precursors in the presence of a liquid solvent and lubricants. Thermoplastic resins such as Nylon, polystyrene, polycarbonate, acrylonitrile butadiene styrene are coated with metal flakes in a composition ranging from 0.5 to 50% by weight. The composite undergoes a bonding process to improve its adhesion and uniformity. The metal flake-based resin composites are used for additive manufacturing by selective laser sintering or other heating methods such as resistance heating at temperature ranging from 150 to 280° C.

### BACKGROUND OF THE INVENTION

### Field of Invention

The present disclosure pertains to additive manufacturing systems and methods for printing three-dimensional (3D) parts and support structures. In particular, the present disclosure relates to consumable materials for printing 3D parts and support structures using powder-based additive manufacturing processes, such as selective laser sintering or other heating methods.

### Description of Prior Art

Additive manufacturing, or commonly 3D printing, has received much attention over recent years. A 3D printer receives and follows instructions from a digital file that is created using 3D modeling software, and prints material layer by layer with precision. This is advantageous over traditional manufacturing techniques as it is capable of quickly producing a unique object without the need for special tooling. Complex geometries and assemblies with multiple components can be simplified to fewer parts with a more cost effective assembly. The technology is rapidly growing and becoming increasingly well known as it reshapes the way people look at manufacturing.

There are many different technologies available for 3D printing purposes. Two well developed technologies include fused deposition modeling (FDM) and powder bed fusion (PBF). In FDM, parts are built layer-by-layer from the bottom up by heating and extruding thermoplastic filament commonly made of polylactic acid (PLA) or acrylonitrile butadiene styrene (ABS). Its drawbacks include low printing resolution, often with visible seam lines, and possible delamination due to temperature fluctuation in depositing ultrafine beads.

PBF methods use either a laser or electron beam to fuse powder materials together. A commonly used technique is selective laser sintering (SLS). SLS uses a laser as the heating source to sinter powdered material, aiming the laser at points in space as defined by a 3D model, binding the powder material together to create a solid structure. Depending on the melting temperature of the powder material, SLS technologies have two variations: low temperature SLS for printing thermoplastic resin powders and high temperature laser sintering for printing metal powders. Nylon 12, or polyamide 12, is a common thermoplastic resin for SLS additive manufacturing with a melting temperature around 180° C. A laser beam can fuse thermoplastic resin powders in a spread layer, resulting in 3D printed parts with typically 60% of solid density. It is possible to print complex functional parts by SLS without the need of a support structure material. Other thermoplastic resins as well as colored resin powders can also be used to print a variety of prototypes with matte surface texture. In general, plastic parts made by additive manufacturing are less rigid, lack of wear resistance, and low in tensile properties due to the porous nature. So far SLS has mainly been used for rapid prototyping and for low-volume production of component parts. Some post finishing treatment such as painting is practiced to make the 3D printed parts appealing.

In order to print thermoplastic resin with metal features, the 3D printer maker, EOS, offers an Al/Nylon powder printing Alumide-polyamide (gray color aluminum filled), in a high metal powder portion (over 40% aluminum powder by weight in Alumide). The printed parts with Alumide are aimed at better high temperature performance, thermal conductivity, and high stiffness, with somewhat metal look. However, the printed appearance is rather dull due to the small size metal powder particles. EOS also offers glass beads filled polyamide, carbon filled polyamide for additive manufacturing.

Similar to SLS, a limited selection of metal and alloy powders in a specific size range can be sintered layer-by-layer by direct metal laser sintering (DMLS) with a high powered laser, typically 200 W. DMLS can achieve quick production of a unique part in a relatively short development time. However, DMLS has to handle metal powders with high melting points, therefore with high running costs as a result of material waste. The required high laser sintering temperature, generally over the melting point of the metal powder demands careful handling of the printing platform. This makes the high temperature 3D printing equipment complicated and therefore very expensive, mostly costing more than half a million dollars each. The printed 3D parts possess high surface roughness and are prone to structure shrinkage during printing.

Presently, there is no cost effective direct selective laser sintering process to print 3D prototypes with a metallic appearance. U.S. Pat. No. 7,141,207 described a 3D printing rapid prototyping process using Al/Mg particles coated with a metal powder such as copper, nickel, zinc, or tin to prevent oxidation of the Al/Mg particles. When alloyed with the aluminum or magnesium core metal, the composite material melts below the liquidus temperature of the core. In this case, micron size metal particles are generally not in an attractive metallic appearance.

Metal coated composites are used in powder coating compositions. U.S. Pat. No. 5,198,042 described an aluminum alloy powder for coating materials. An amorphous aluminum alloy consisting essentially of 83˜91% Al, 0.5˜5% Ca and 8˜12% Ni (all in atomic percentage), and comprising a leaf-shaped particle having a thickness of 0.3 to 3 μm, a minor axis of from 10 to 150 μm, a ratio of the minor axis to a major axis of from 1 to 3, and an aspect ratio which is the ratio of the minor axis to the thickness of from 3 to 100 was applied with a resin compound for coating applications. The aluminum alloy powder can impart better hiding power and reflecting properties, even when added in a smaller quantity than conventional powders.

U.S. Pat. No. 7,244,780, assigned to International Coatings Limited, described compositions comprising a film forming polymer, a pigment proving a metallic effect and a stabilizing additive. The resultant coating on a substrate inhibits degradation of the metallic pigment in the presence of oxygen and water.

### SUMMARY OF THE INVENTION

An aspect of the present disclosure is related to a consumable material for use in an additive manufacturing system. The consumable material includes a metal coated thermoplastic composite material with metallic appearance, improved mechanical properties and durability. Metal flakes are made of but are not limited to base metals such as aluminum, chromium, cobalt, copper, iron, nickel, tin, titanium, zinc, and precious metals such as silver, gold, and platinum, and their alloys, e.g., stainless steel, brass, bronze, and more. Thermoplastic resins such as Nylon, polystyrene, polycarbonate, acrylonitrile butadiene styrene, polylactic acid, and polyetherimide are applied to mix and coat with metal flakes to form additive manufacturing composites.

Another aspect of the present disclosure is related to a method of manufacturing the thermoplastic composite material. Metal flakes are produced by ball milling of metal powder precursors in ball mills, bead mills or attritors in the presence of a liquid solvent and lubricants. The milled metal flakes may be subject to surface reduction in reducing hydrogen containing atmosphere, or annealing in a protective gas atmosphere.

It is therefore an object of this invention to combine the unique reflection properties of metal flakes with thermoplastic resin powders as a binder for low temperature selective laser sintering additive manufacturing. The 3D printing could yield rapid prototypes with metallic appearance, improved mechanical properties, and durability.

Metal flakes have average sizes (D₅₀) of 5 to 50 microns, preferably 20-30 microns, and thickness of 0.2 to 2 microns, can be added into thermoplastic resins to form composites. The metal flakes are mixed and further bonded onto the thermoplastic resin surface at a temperature below the surface softening temperature of the thermoplastic resin.

Metal flakes can be chemically modified by electrochemical processing such as anodic oxidation, electroless plating, or electroplating to alter the surface appearance or composition to meet wide additive manufacturing needs.

Another aspect of the present disclosure is related to a method of building a 3D part with an additive manufacturing system. Composition of metal flakes in the thermoplastic resin composites ranges from 0.5 to 50 wt % (weight percentage). The metal flake-based resin composites can be 3D printed by selective laser sintering or other heating methods such as resistance heating and electron beam heating at temperature ranging from 150 to 280° C. depending on the specific resin material.

### BRIEF DESCRIPTION OF THE DRAWINGS

FIG. 1. Microscopic images of admix Nylon 12 powder and aluminum flakes.

FIG. 2. Schematic of metal flake composites manufacturing process.

FIG. 3. Microscopic image of milled and bonded 5 wt % bronze flake/Nylon 12 composite.

FIG. 4 Microscopic image of sintered surface made of bronze flake/Nylon 12 composite after selective laser sintering printing.

### DETAILED DESCRIPTION OF THE INVENTION

This patent describes metal flake/thermoplastic composites for rapid prototypes with metallic appearance and improved mechanical properties used in low-temperature selective laser sintering additive manufacturing. Thermoplastic resin particles such as Nylon 12 with average particle sizes (D₅₀) in the range of 20-100 microns are used as base materials.

Micron sized metal powders in general are not impressive in their metal colors due to the scattering of incident light. Metal flakes derived from metal powders in the range of 5-50 microns (D₅₀) are often shining and attractive in their metallic appearance due to the effective reflection of incident light with tiny mirror-like smooth flake planes to the human eyes. If metal flakes are too fine, they tend to loss its metallic appearance due to high scattering to the incident light rather than reflection. On the other hand, larger metal flakes for example over 50 microns are difficult to attach on smaller thermoplastic resin particles, and deteriorate powder flow-ability.

This is fundamental to decorative metallic coatings. Metal flakes have found many applications in decorative coating, conductive inks, wearing resistant cookware, lubricant, etc. The metallic paints used to coat modern passenger vehicles contain metal flakes. In the spray coating industry, metal flakes are added into plastic resins to produce coatings with metallic appearance.

Micron size metal flakes can be produced by compaction milling of metal powders with a desired particle size distribution. Ball mills, beads mills and attritors are generally used with the presence of grinding media such as hard steel balls, stainless steel balls, ceramic beads, and glass beads. Milling can be done by either drying milling with or without a protective gas depending on the metal powder nature, or wet milling in a solvent such as mineral spirits, mineral oils and ethylene glycol to prevent metal flake surface oxidation and facilitate heat dissipation during grinding. Fatty acids such as oleic acid and stearic acid can be used as lubricant to prevent particle agglomeration and fresh surface from oxidation when exposed to air after milling and solvent evaporation.

By selecting raw metal powders from base metals and precious metals, various types of metal flakes can be made by the ball milling process for additive manufacturing. Ball mills are in general charged with a ball shaped medium of an average diameter of ¼″ or less. Alloy powders of base metals are also useful in making metal alloy flakes with different color tones. Metal alloy flakes include but are not limited to base metals such as nickel, iron, copper, zinc, tin, aluminum, titanium and precious metals such as silver, gold, and platinum, and their alloys for example, stainless steel, brass, bronze, and more. Cu—Zn alloy (brass) flakes could exhibit tones of reddish, yellowish and yellow colors with zinc atomic percent at 10 at %, 15 at % and 30 at %, respectively. These make a wide spectrum of brass parts made by additive manufacturing with metal flake composites.

The milled metal flakes may be subject to surface reduction in a reducing hydrogen containing atmosphere, or annealed in a protective gas stream to modify the surface behavior for specific additive manufacturing. Alternatively, metal flakes can be chemically modified by electrochemical processing such as anodic oxidation, electroless plating, or electroplating to alter the surface appearance or composition.

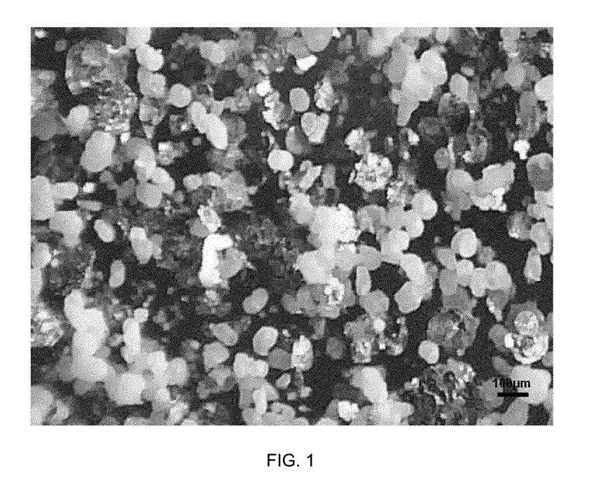

The processed metal flakes can be added into thermoplastic materials through blending and/or milling to produce a uniform admix material suitable for 3D printing. Milling with zirconia beads improves the milled composite powder flow-ability, as tested with a Hall flow-meter. FIG. 1 shows a microscopic image of admix of aluminum flake/Nylon 12 composite. The white particles are plastic resin surrounded by metal flakes. Presence of lubricant in a small amount on the metal flake surface helps adhesion of metal flake onto the thermoplastic resin surface.

Composition of metal flakes in the thermoplastic resin composites ranges from 0.5 to 50 wt %. The metal flake-based resin composites can be 3D printed by selective laser sintering or other heating methods such as resistance heating and electron beam heating at temperature ranging from 150 to 280° C. depending on the specific resin material.

Coating of thermoplastic resins can also be done by spraying a metal flake containing solvent onto agitated thermoplastic resin powders in a closed container at temperature up to 150° C. The coated composites are subject to solvent separation and drying before additive manufacturing.

This patent incorporates aforementioned metal and alloy flakes with thermoplastic resins such as Nylon or PLA by mechanical mixing, and coating to form additive manufacturing composites. Micron size metal flakes of 5-50 microns (D₅₀) in size, preferably 5-30 microns, can be added into the resin composites. The metal and alloy flakes have a thickness of 0.2-2 microns.

As an extension of this invention, mica flakes with thickness in the range of 0.2-2 microns and 5-50 microns in size can be used in lieu of metal flakes to coat thermoplastic resins for making mica flake/thermoplastic resin composites.

To ensure uniform composition and good 3D printing performances, metal flakes are bonded onto thermoplastic resin surface in a series of operations comprising

a) drying blending metal powder precursor in a mixing device such as a V-cone blender, even electrostatic mixing to avoid particle segregation during transportation;

b) milling of the mixture in a beads mill to improve the composite powder flow-ability,

c) bonding said metal flakes onto the surface of said thermoplastic resin powder at a temperature below the surface softening temperature of said thermoplastic resin for a duration ranging from 5 minutes to 2 hours.

d) post-milling and screening said metal flake composites for better powder quality control if necessary.

The bonding step takes advantage of the base thermoplastic resin surface softening behavior in its glass transition region from a solid to a more or less viscous liquid state over a comparatively broad temperature range. Above its glass transition temperature T_{g}, and below its melting point Tₘ, the physical properties of a thermoplastic resin change drastically without an associated phase change. The onset of the polymer surface softening causes it tacky and penetrable by metal flake particles.

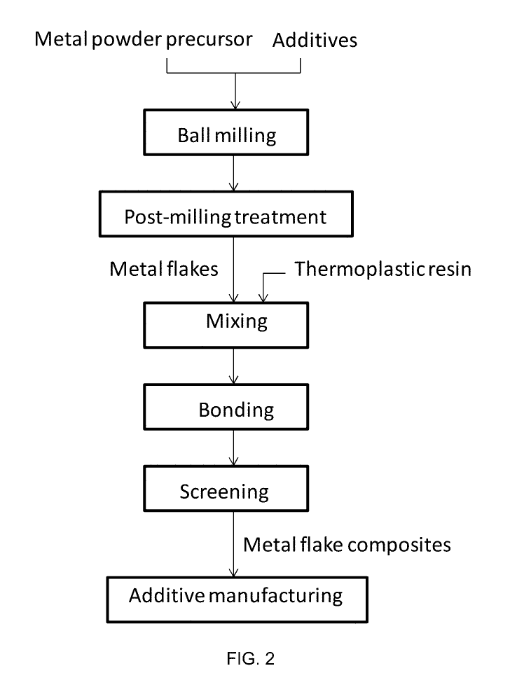

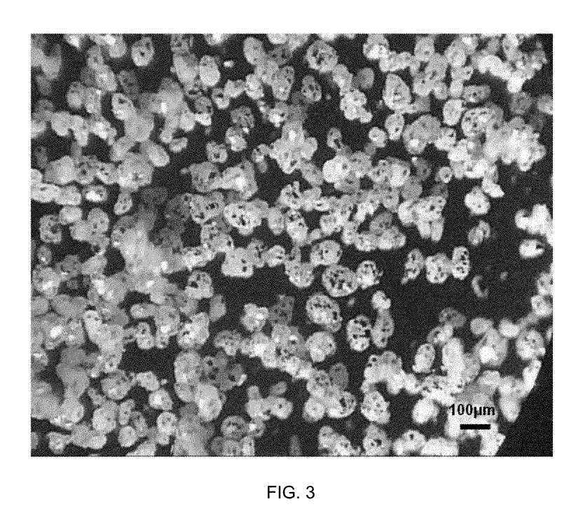

FIG. 2 is a schematic of metal flake composites manufacturing process. Bonding can be done by heating the composite precursors in an oven at a temperature lower than the surface softening temperature of the resin component, typically 120-200° C., or quick heating in a fluid bed. Electrical resistance heating and/or infrared heating can be applied in static ovens or continuous conveyer belt ovens for the bonding operation. FIG. 3 is a microscopic image of milled and bonded 5 wt % bronze flake/Nylon 12 composite material, with a partially covered thermoplastic resin surface (dark metal flake spots covering white resin particles). The bonded metal flake Nylon composites are robotic in handling with no concern of metal flake segregation during transportation and coating practice, therefore, suitable for additive manufacturing processing.

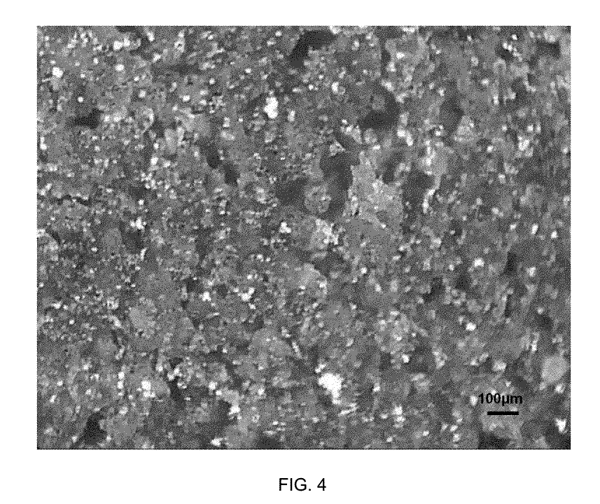

Composition of metal flakes in resin composites ranges from 0.5 to 50 wt %. The metal flake-based resin composites can be 3D printed by selective laser sintering at temperature ranging from 150 to 280° C., pre-determined based on the melting point of specific thermoplastic resins. For example, metal flake/Nylon composites could be 3D printed at a heated bed temperature of 175° C. and fused at 180-220° C. With the 3D laser fusion, the metal flakes have a tendency of laying flat on the resin surface as a result of minimizing the surface energy. Due to the addition of metal flakes, heat transfer during laser sintering is much faster in comparison with pure plastic resin powders, resulting in a fast printing speed, uniform layer coating bed heating and sintering and better binding layer to layer, resulting in more dense printed parts. A demonstration of 3D printing is practiced using an EOSINT P395 thermoplastic laser sintering system with a 70 W laser for printing functional parts, fashion items and test specimen with bronze flake/Nylon 12 composite materials. Upon laser exposure, the composite material is sintered instantly with a clearly defined pattern in metallic appearance. FIG. 4 is a microscopic image of sintered surface made of bronze flake/Nylon 12 composite. The printed parts may be subject to surface finishing treatment such as sand blasting, ultrasonic solvent washing, dipping in a heat transfer fluid, or laser surface cleaning to further enhance the surface appearance.

Besides selective laser sintering (SLS), other heating methods such as resistance heating and electron beam heating can also be applied to 3D print metal flake resin composite materials. The composite powders are also applicable to 3D printing with direct powder fusion deposition. Due to the good flow-ability, the metal flake composite material can be fed directly through an auger screw feeder to a 3D printing head equipped with a cartridge heater for additive manufacturing.

Benefits of additive manufacturing using metal flake-based resin composites include the following:
Metallic appearance with improved surface finishing;
Stronger and stiffer mechanical properties;
Improved wear resistance and UV resistance;
Low cost additive manufacturing at low temperature;
Good thermal conductivity for a uniform powder bed temperature;
Wide availability of metal and alloy flakes.

Metal flake composites are particularly useful in additive manufacturing of fashion design, educational models, concept models, functional prototypes, and manufacturing aids, and low-volume end user parts with metallic appearance and improved mechanical properties. High temperature 3D printing is thus avoided, offering an environmentally friendly solution for quick industrial prototyping.

Unsintered powder composites can be separated from sintered structure, and recycled for partial reuse after sieving and reconditioning. Below are examples of metal flake formation and composite making targeted for additive manufacturing application.

### Example 1

Nickel flakes were made by ball-milling carbonyl nickel powder N24 (Jinchuan Group) in a lab ball mill. High chrome steel balls of ¼″ diameter were used with a ball to metal powder volume ratio of 40:1. Odorless mineral spirits (Recochem) was used as the solvent, and stearic acid was used as a lubricant. Solvent to powder volume ratio was controlled at 40:1, and the lubricant content in metal powder was 0.5 wt %. Ball milling was carried out at 45 rpm for 3 hours with close monitoring of the milling jar temperature. After milling, the solvent was decanted and the resultant nickel flakes are dried at 60° C. under vacuum. The as-produced nickel flakes exhibited metallic luster appearance. Typical properties of the produced nickel flakes are listed in Table 1.

The aforementioned nickel flake powder was mixed with Nylon 12 resin powder (50-60 microns size D₅₀) in 30 wt % with a V-cone blender, conditioned ready for SLS 3D printing. Test bars were made at simulated 3D printing conditions of 180° C. for normal SLS sintering. The test bar showed metallic appearance, with a matt surface texture. Tensile strength test indicated much improved results in comparison with pure Nylon products, and the finished object is ˜60% lighter than a metal part made of pure nickel.

Similarly, iron flakes were prepared by ball-milling soft carbonyl iron powder F02 (Jinchuan Group) in a lab ball mill. High chrome steel balls of ¼″ diameter were used with a ball to metal powder volume ratio of 30:1. Odorless mineral spirits (Recochem) was used as solvent, and stearic acid was used as a lubricant. Ball milling was carried out at 45 rpm for 2 hours with close monitoring of the milling jar temperature. After milling, the solvent was decanted and the resultant iron flakes were dried at 60° C. under vacuum. Typical properties of the produced iron flakes are listed in Table 1.

TABLE 1
Typical properties of metal flakes

| Metal Flake | A.D. | | Av. Size D₅₀ | | Thickness | Assay |
|---|---|---|---|---|---|---|
| Nickel flake | 0.6-0.7 | g/cm³ | Up to 40 | μm | 0.5-1.2 μm | Ni > 99.0 wt % |
| Iron flake | 0.6-0.8 | g/cm³ | 25-40 | μm | 0.5-1.5 μm | Fe > 99.6 wt % |
| Aluminum flake | ~0.2 | g/cm³ | 15-25 | μm | 0.5-1.0 μm | Al > 94.0 wt % |
| Zinc flake | 0.6-0.8 | g/cm³ | 8-18 | μm | 0.5-1.0 μm | Zn > 95.0 wt % |
| Bronze flake | 0.5-0.7 | g/cm³ | 5-12 | μm | 0.5-0.8 μm | 75 at % Cu/ |
| | | | | | | 25 at % Sn |

### Example 3

Zinc flakes were produced by ball-milling electrolytic zinc powder in a lab ball mill. High chrome steel balls of ¼″ diameter were used with a ball to metal powder ratio of 20:1. Odorless mineral spirits (Recochem) was used as the solvent, and stearic acid was used as a lubricant. Ball milling was carried out at 45 rpm for 60 min with close monitoring of the milling jar temperature. After milling, the solvent was decanted and the resultant zinc flakes were dried at 60° C. in atmosphere. Typical properties of the produced zinc flakes are listed in Table 1.

The aforementioned zinc flake powder was dry blended with Nylon 12 resin powder (50-60 microns size) in 5 wt % in a V-cone blender for 30 min at 60 rpm. After blending, the composite powder was heated to 120° C. for 30 min to soften the resin powder and allow the zinc flake to adhere to the outer surface of the resin as a bonding process, conditioned ready for SLS 3D printing.

### Example 3

Aluminum flakes were made by ball-milling aluminum powder (EMD Chemicals) in a lab ball mill. High chrome steel balls of ¼″ diameter were used with a ball to metal powder volume ratio of 20:1. Odorless mineral spirits (Recochem) was used as the solvent, and stearic acid was used as a lubricant. Ball milling was carried out at 30 rpm for 60 min with close monitoring of the milling jar temperature. After milling, the solvent was decanted and the resultant aluminum flakes were dried at 60° C. in atmosphere. Aluminum flakes with metallic shine effect were thus produced. Typical properties of the produced aluminum flakes are listed in Table 1.

The aforementioned aluminum flake powder was ball-milled with Nylon 12 (EOS PA2200) resin powder (50-60 microns size) in 10 wt % in a lab ball mill with 4 mm high chrome steel balls for 30 min at 60 rpm. After milling, the composite powder was heated to 120° C. for 30 min to soften the resin powder and allow the aluminum flake to adhere to the outer surface of the resin as a bonding process, conditioned ready for SLS 3D printing.

### Example 4

A ball milled bronze flake powder (copper-tin powder) was dry blended with Nylon 12 (EOS PA2200) resin powder (50-60 microns size) in 5 wt % in a V-cone blender for 30 min at 60 rpm. After blending, the composite powder was heated to 120° C. for 30 min to soften the resin powder and allow the bronze flake to adhere to the outer surface of the resin as a bonding process, conditioned ready for SLS 3D printing. Table 2 lists typical properties of bronze flake composite powders. SLS 3D printing using 5 wt % bronze flake/Nylon 12 composite material produced 3D parts with over 10% density increase in comparison with parts printed with the base′ Nylon 12 resin.

TABLE 2
Bronze flake composite powder properties

| Property | Typical range | Unit | Test method |
|---|---|---|---|
| Composition | | | |
| Nylon 12 | 90-98 | wt % | Leco |
| Bronze flake | 2-10 | wt % | ICP-MS |
| Lubricant | 0.1-0.5 | wt % | Leco |
| Mean particle size D₅₀ | 40-60 | micron | Image analysis |
| Melting point (polymer) | 180-185 | ° C. | Electrothermal |
| Apparent density | 0.5-0.9 | g/cm³ | Carney |
| Color | Beige-tan | N/A | Visual inspection |

1. A coated thermoplastic powder composite material, for use in additive manufacturing, comprising
a. a thermoplastic resin powder in the size range of 20-100 microns;
b. at least one metal flake powder with thickness in the range of 0.2-2 microns, and an average size in the range of 5-50 microns (D₅₀), coated on the outside surface of said thermoplastic resin powder; said metal flake powder is in an amount of 0.5% to 50% by weight of said composite material.

2. The composite material of claim 1 in which the metal flake powder is in an average size range of 5-50 microns (D₅₀).

3. The composite material of claim 1 in which the thermoplastic resin powder comprises at least one selected from the group consisting of polyamide 12, polystyrene, polycarbonate, acrylonitrile butadiene styrene, polylactic acid, polyetherimide, castable wax, and co-polymers.

4. The composite material of claim 1 in which the metal flake powder comprises at least one selected from the group consisting of:
a. base metals such as nickel, iron, copper, zinc, titanium, aluminum, and tin;
b. precious metals such as silver, gold, and platinum;
c. metal alloys such as stainless steel, brass, and bronze.

5. The composite material of claim 1 further comprising mica flakes with thickness in the range of 0.2-2 microns, and an average size in the range of 5-50 microns (D₅₀).

6. A method of making the composite material of claim 1 comprising:
a. drying blending metal powder precursor in a mixing device such as a V-cone blender;
b. ball milling of said metal powder precursors in ball mills, bead mills, or attritors in the presence of a liquid solvent and lubricants;
c. subjecting milled metal flakes to surface reduction in a reducing hydrogen containing atmosphere, or annealed in a protective gas atmosphere.
d. dry blending said metal flakes with a thermoplastic resin powder;
e. bonding said metal flakes onto the surface of said thermoplastic resin powder at a temperature below the surface softening temperature of said thermoplastic resin for a duration ranging from 5 minutes to 2 hours;
f. screening said metal flake composites for precise particle size control.

7. The method of claim 6 further comprising evaporating the liquid solvent from the metal flakes

8. The method of claim 6 further comprising chemically modifying the metal flakes by electrochemical processing such as anodic oxidation, electroless plating, or electroplating to alter the surface appearance or composition.

9. The method of claim 6 further comprising post-milling following bonding in a beads mill to improve powder composite flow-ability.

10. The method of claim 6 further comprising bonding of the metal flakes to the thermoplastic resin in a fluid bed suspension.

11. The method of claim 6 further comprising:
a. coating the thermoplastic resin with a slurry consisting of metal flake, a solvent such as mineral spirit, and additives by either wet milling or spray coating;
b. evaporating the solvent by heating in atmosphere or vacuum.

12. A method of using the composite material of claim 1 comprising:
a. selective laser sintering at a temperature range from 150 to 280° C.;
b. selective laser melting at a temperature range from 150 to 280° C.;
c. electrical resistance heating at a temperature range from 150 to 280° C.;
d. electron beam heating at a temperature range from 150 to 280° C.

13. The method of claim 12 further comprising mixing two or more metal flake/resin composites for additive manufacturing of prototypes with combined features of individual metal flake/resin composites.

14. The method of claim 12 further comprising using multiple 3D printing heads for printing metal flake/resin composites with different features.
